(19) United States
(12) Patent Application Publication
(10) Pub. No.: US 2005/0209003 A1
(43) Pub. Date: Sep. 22, 2005

(54) Method for automated enrolling in a player account

(75) Inventor: William R. Adams, Las Vegas, NV (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: veXpress International, Inc., Las Vegas, NV (US)

(21) Appl. No.: 10/950,849

(22) Filed: Sep. 27, 2004

Related U.S. Application Data
(60) Provisional application No. 60/553,872, filed on Mar. 17, 2004.

(51) Int. Cl. A63F 13/00

(52) U.S. Cl. 463/42; 463/29

(57) ABSTRACT

A method for operating a network of video machines including the steps of providing a video machine that is part of the network, inputting and storing a value of credits, determining and verifying if a player is a member of a player club, determining whether the player wants to be a member if the player is not a member, enrolling the player at the video machine if the player is not a member, playing the video machine, adding and debiting credits to the stored value of credits for credits earned or lost during play, encoding the value of any credits remaining and data associated with the player onto the readable/encodable card, and ejecting the readable/encodable card, whereby no interaction with a human being is required by the player to become a member of the player club.

### CROSS REFERENCE TO RELATED APPLICATION

This application claims the benefit of U.S. Provisional Patent Application Ser. No. 60/553,872, filed Mar. 17, 2004, entitled Method for Automated Enrolling in a Player Account.

### BACKGROUND OF THE INVENTION

This invention relates to networked computer controlled video devices such as video gaming machines and video lottery machines, and, more particularly, to control of a video device network, for example, a network of gaming devices or lotteries.

Player tracking information, including demographics, player activity (including amount of time of play, amounts won or lost by the player, bets made by the player, etc.), fraud detection, etc. is of great value to gaming facility owners. This information may be used for, for example, marketing, special incentives for frequent or high betting players, and the like.

In the past, in networks of video systems such as gaming systems and lottery systems, when a player desired to join a player club, the player had to enroll in the club by physically going to an appropriate kiosk and interacting with a human operator of that kiosk to enroll in the player club. The present invention is directed to a method for automated enrolling in a player account wherein a player may enroll in a player account at any video machine in the network. That is, rather than requiring a player to physically go to a kiosk or other location to sign up for a player account, the player can walk up to any video machine that is configured in accordance with the present invention, enroll in a player account, and begin play on that system. No human intervention is required.

Patents related to the present invention include the following:

U.S. Pat. No. 6,280,328 (Holch et al.) is directed to a coinless video game system that includes a plurality of video game terminals, a game server corresponding to each player terminal and a central control network for administering and controlling games and player accounts. A player initially establishes a player account in the central control network and receives a player identification card bearing the player's account number and other relevant information. Players use these cards to establish sessions at a player terminal. The server provides a random number to each player terminal at predefined intervals to determine wins and losses for each game selected by a player. Waged amounts are then debited or credited to the player's account in the central control network. Players may redeem any account balance from a cashier associated with the central control network. The central controller keeps track of all player activity information.

U.S. Pat. No. 5,836,817 (Acres et al.) is directed to a method and apparatus for operating networked gaming devices. This is a system for monitoring and configuring gaming devices interconnected over a high speed network. Each gaming device includes an electronic module which allows the gaming device to communicate with a floor controller over a current loop network. The electronic module includes a player tracking module and a communication node. The player tracking module includes a card reader for detecting a player tracking card inserted therein which identifies the player. The data communication node communicates with the gaming device. The gaming device reconfigures its payout schedule responsive to reconfiguration commands from the communication node to provide a variety of promotional bonuses.

U.S. Pat. No. 5,429,361 (Raven et al.) is directed to an information and communication system for gaming machines that permits communication between gaming machines and a central control system. The system includes a central data processor, a control unit for each gaming machine within the system which is in communication with the central data processor and a user interface which includes a keypad, a card reader, and a display. The control unit can be used to identify special players and transmits messages, including promotional messages, for display. The control unit can accept personal data from a card inserted into the card reader and can be enabled by a personal identification number entered on the keypad. The system provides automated maintenance, event tracking, employer/player interaction from the game to the central data processor, cashless operation of gaming machines, reserving gaming machines, and other functions.

None of the known prior art teaches a method of operating a player account where a player may enroll in the player account any video machine in the network.

All references cited herein are incorporated herein by reference in their entireties.

### BRIEF SUMMARY OF THE INVENTION

A method for operating a network of video machines is provided which includes the steps of providing a video machine that is part of the network of video machines, inputting a value of credits into the video machine and storing the value of credits on the video machine, determining and verifying whether a player is a member of a player club, determining whether the player wants to be a member of the player club if the player is not a member of the player club, and enrolling the player at the video machine if the player is not a member of the player club where the player wants to be a member of the player club. The method further includes the steps of playing the video machine and adding and debiting credits to the stored value of credits for credits earned or lost during play of the video machine, encoding the value of any credits remaining and data associated with the player to identify the player in the player club onto the readable/encodable card, and ejecting the readable/encodable card having the remaining value of credits and player data encoded thereon for receipt by the player. No interaction with a human being is required by the player to become a member of the player club.

The method may include the step of inputting a readable/encodable card into the video machine by the player where the card has player data and available credits encoded thereon. The step of determining and verifying if a player is a member of a player club may be based on data encoded on the readable/encodable card. The step of determining and verifying if a player is a member of a player club may include the step of entering a player identification number (PIN) by the player and comparing the PIN entered by the player to a database of PINs. Preferably, this is accomplished at the network level.

A step of printing a value of any remaining credits on the surface of the readable/encodable card may be included. Optionally, any printed value may be eradicated that existed on the surface of the readable/encodable card.

The video machine may have a stored quantity of the readable/encodable cards, where each card of the stored quantity of cards has a zero balance of money and no player data encoded thereon.

The step of encoding may include encoding onto, for example, a magnetically encodable card, a bar code encodable card, an electronically encodable card, and the like. The video machine may retain any readable/encodable card having a zero balance encoded thereon. The video machine may be connected to a global network of video machines. The video machine may be, for example, gaming machines (such as slot machines, poker machines, lottery machines, sweepstakes machines, etc.)

The step of inputting a value of credits may be accomplished by inputting, for example, a credit card, bank card, debit card, etc. or currency. A step of signaling the video machine by the player that play is over may initiate the steps of encoding and ejecting the readable/encodable card. Game usage data associated with the encoded card may be collected by the network. A step of erasing data encoded on any readable/encodable card and adding the erased card to the stored quantity may be included. The step of enrolling the player at the video machine may include inputting personal information from the player into an input device on the video machine.

### BRIEF DESCRIPTION OF SEVERAL VIEWS OF THE DRAWINGS

The invention will be described in conjunction with the following drawings, wherein:

FIG. 1 is a schematic diagram of a method for operating a network of video machines in accordance with a first preferred embodiment of the present invention, where no interaction with another human being is required by the player to become a member of a player club; and

FIG. 2 is a simplified front elevation view of a video machine for use with the method of the present invention.

### DETAILED DESCRIPTION OF THE INVENTION

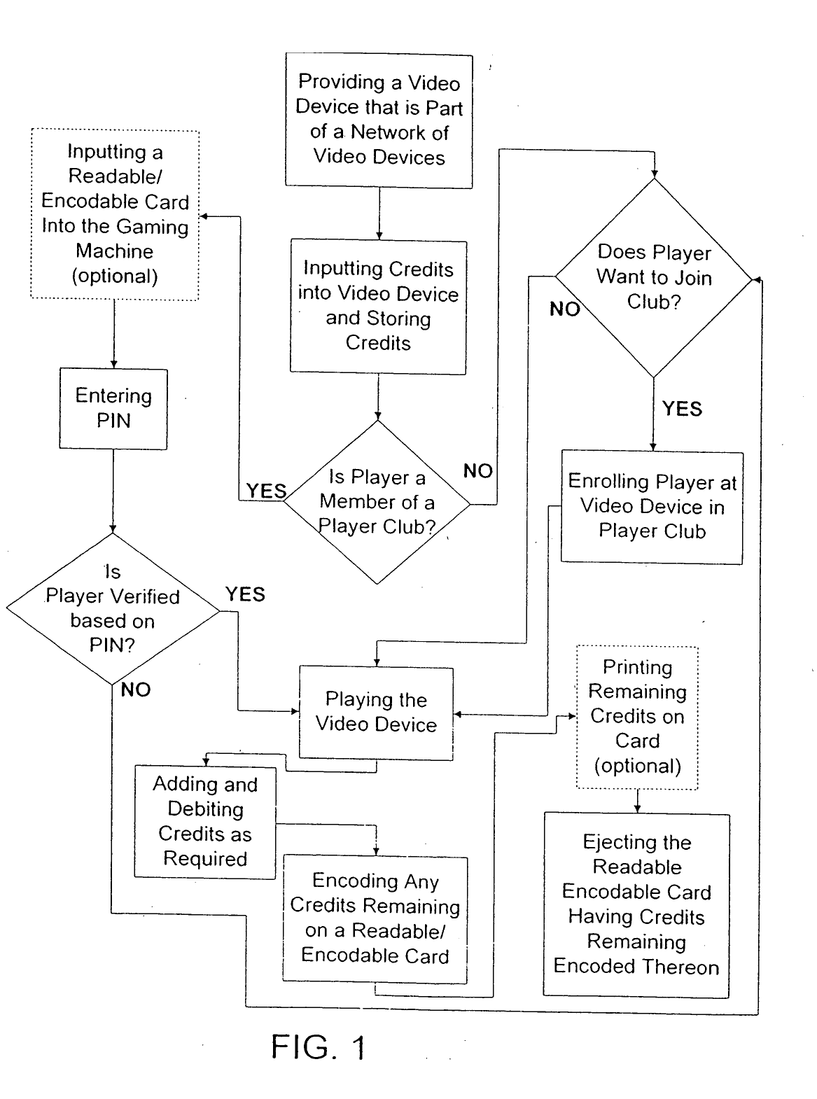

Referring now to the drawings, there is shown in FIG. 1 a schematic diagram of a method for operating a network of video machines in accordance with one preferred embodiment of the present invention.

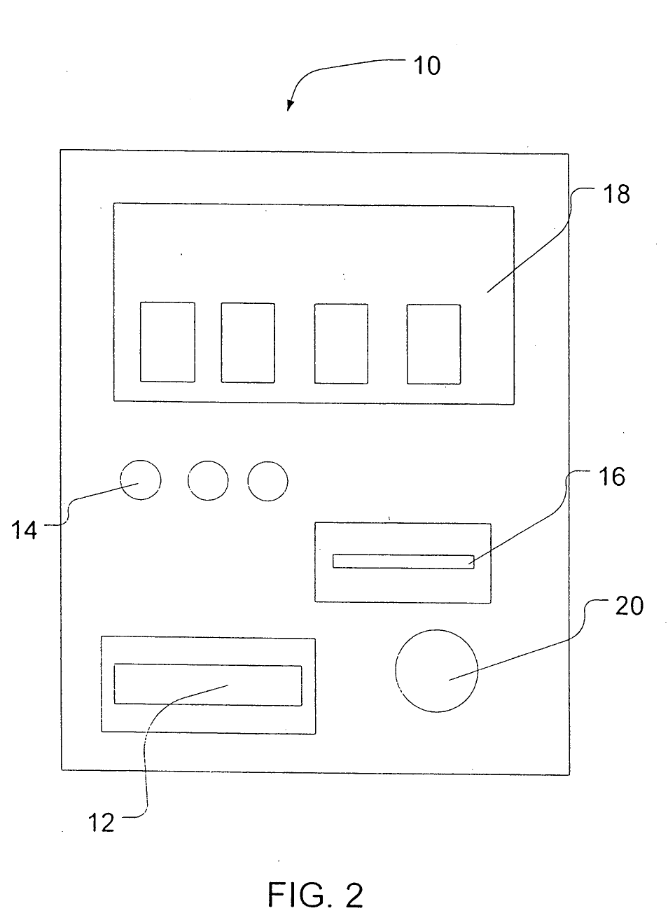

The method first includes the step of providing a video machine 10 that is part of a network of video machines 10. A simplified view of the video machine 10 is shown in FIG. 2. The video machines 10 in the network may be any type of known video system, for example, video slot machines, video poker machines, lottery machines or substantially any other known type of video machines. The video machines 10 are connected to a network such that data from the various machines is compiled at one or more central server. The network may be a single local network or it may be a large interconnected network of smaller networks, including, for example, a worldwide, global network. Substantially any type of network that connects video machines, lottery machines or other game machines or similar machines, including the internet, is intended to be within the scope of this invention.

When a player that desires to play the video machine 10 walks up to the video machine 10, he or she inputs a value of credits into the video machine 10 by use of a money input device 16. This may be accomplished using currency, credit cards, debit cards, bank cards, and the like. The number of credits obtained from the player is then stored on the video machine 10 in memory.

The network, through the video machine, then determines whether a player is a member of a player club associated with the video machine 10. The video machine may ask the player if he or she is a member and may ask if the player has a previously provided readable/encodable card to insert into the video machine 10. The video machine 10 may also ask for a personal identification number (PIN). Using this information, through the network, the video machine 10 verifies that a player is a bona fide member of the player club. The determination is verified while the player is physically at the video machine 10. If the player is not a member of the player club or cannot be verified, the video machine then asks the player whether he or she wants to become a member of the player club. If the player does want to become a member of the player club, the player may enroll in the player club at the machine by providing any relevant personal data directly into the video machine by use of a player input device 14 on the video machine 10 such as a keyboard, scroll wheel, or similar input devices.

The player then plays the video machine 10 for one play or multiple plays. Credits are added and debited to the value of credits originally input into the video machine 10 for wins and losses based on the games played on the video machine 10. When play is halted, the video machine 10 encodes the amount of any credits remaining onto a readable/encodable card (either the same card as initially inserted or on a new card). Optionally, the value of any remaining credits may also be imprinted on the surface of the readable encodable card. The card is then ejected from the card encoder/reader 12 where the card has the remaining value of credits encoded thereon along with any identifying information to associate the player with his data in the player club. Again, no interaction with another human being is required by the player to become a member of the player club.

As indicated, when network (through the video machine 10) determines if the player is a bona fide member of the player club based on data stored on the readable/encodable card, a PIN system, as well known, may be used. Here, when the card is input into the video machine 10, a display 18 on the video machine 10 asks that the player provide a PIN through, for example, player input device 14. The determination is verified while the player is physically at the video machine 10. The PIN is compared to a database of PINs of the players in the player club such that the player is positively identified.

Preferably, each video machine 10 has a stored quantity of the readable/encodable cards. Each of these cards effectively has a zero balance and no specific player data encoded thereon. Therefore, whenever a new player comes to the machine, he or she may be provided with a player card that is ejected from the machine with any unused credits along with player identification data encoded thereon. If all credits are used such that there is a zero balance, the card is preferably retained by the video machine 10, and may be cleared of relevant data and stored for future use.

The readable/encodable card may be, for example, a magnetically encodable card, a bar code encodable card, an electronically encodable card, or any other known type of card that is capable of being encoded with data.

When the player desires to cease playing on the video machine 10, the player may signal the video machine 10 that play is to be ceased, by, for example, pressing a stop play button 20. Pressing the stop play button 20 initiates the process of encoding and ejecting the readable/encodable card. Alternatively, optionally, the player may cash out at the machine and receive, for example, currency.

Player tracking information may be collected, for example, information including demographics, player activity (including amount of time of play, amounts won or lost by the player, bets made by the player, etc.), fraud detection, etc. This information may be used for, for example, marketing, special incentives for frequent or high betting players, and the like.

The card may preferably be used on any video machine 10 in the network.

Preferably, the player card being used is retained in the machine being played during the duration of play. If, when play is halted, no stored credits remain, the card may be retained within the video machine 10 for future use for another player.

As indicated above, player identification is associated with the readable/encodable card. This data may include, for example, game usage data associated with the encoded card. Optionally also, the personal identification number (PIN) may be associated with the encoded card. This PIN may be required to be entered to use a card. This identifies a specific player associated with the encoded card. However, for players that desire to remain generally anonymous, no specific personal information may be required.

For example, the video machine 10 may ask the player if he or she is a member of the casino club. The player may then enter his or her PIN to identify the player to the casino. Tracking and related functions for that particular player may then be initiated. For example, a player may obtain cash awards, hotel awards or other complementary services.

If a player plays and uses all the credits on the player card and then desires to halt play, the video machine 10 may then erase the data associated with the card and reuse the card for future plays by a different player.

Prior to the present invention, previous video machines dispensed encoded tickets, for example, bar coded tickets with a player's credits encoded or otherwise printed thereon. The player then takes that ticket to a cashier or a redemption kiosk to get cash for credits owed to him or her.

In the present invention, optionally, the readable/encodable card may be imprinted on its surface with a value of credits remaining to be used by the player. A further option includes the ability of the video machine 10 to erase or otherwise eradicate any previously printed values that existed on the surface of the readable/encodable card. This technology is well known, for example, as taught by U.S. Pat. No. 6,152,620 (Ozawa et al.), the specification of which is hereby fully incorporated by reference.

A major benefit of this system is that it may operate with a very limited number of people. Since the system is networked and fewer or no cashiers or kiosk operators for enrolling players are required, the only people required are people to manage the equipment and service the equipment.

The network preferably operates on a worldwide network such as the internet. However, it is intended that substantially any feasible type of computer network would operate, for example, each video machine 10 could have a modem connected to dedicated local phone line. Other systems may also be incorporated including, for example, satellite communications.

While the invention has been described in detail and with reference to specific embodiments, it will be apparent to one skilled in the art that various changes and modifications can be made therein without departing from the spirit and scope thereof.

1. A method for operating a network of video machines comprising the steps of:
(A) providing a video machine that is part of the network of video machines;
(B) inputting a value of credits into the video machine and storing the value of credits on the video machine;
(C) determining and verifying if a player is a member of a player club;
(D) determining whether player wants to be a member of the player club, if the player is not a member of the player club;
(E) enrolling the player at the video machine if the player is not a member of the player club;
(F) playing the video machine and adding and debiting credits to the stored value of credits for credits earned or lost during play of the video machine;
(G) encoding the value of any credits remaining and data associated with the player to identify the player in the player club onto the readable/encodable card; and
(H) ejecting the readable/encodable card having the remaining value of credits and player data encoded thereon for receipt by the player;
whereby no interaction with a human being is required by the player to become a member of the player club.

2. The method of claim 1, including the step of inputting a readable/encodable card into the video machine having player data and available credits encoded thereon.

3. The method of claim 2, wherein the step of determining and verifying if a player is a member of a player club is based on data encoded on the readable/encodable card.

4. The method of claim 1, wherein the step of determining and verifying if a player is a member of a player club includes the step of entering a player identification number (PIN) by the player and comparing the PIN entered by the player to a database of PINs.

5. The method of claim 1, including the step of printing a value of any remaining credits on the surface of the readable/encodable card.

6. The method of claim 5, including the step of eradicating any previously printed values that existed on the surface of the readable/encodable card.

7. The method of claim 1, wherein the step of providing the video machine includes providing the video machine having a stored quantity of the readable/encodable cards, the stored quantity of cards each having a zero balance of money and no player data encoded thereon.

8. The method of claim 1, wherein the step of encoding includes encoding onto a readable/encodable card of a type selected from group consisting of a magnetically encodable card, a bar code encodable card, and an electronically encodable card.

9. The method of claim 1, including the step of retaining any readable/encodable card having a zero balance encoded thereon.

10. The method of claim 1, wherein the step of providing the video machine includes providing a video machine connected to a global network of video machines.

11. The method of claim 1, wherein the step of providing the video machine includes providing a video machine selected from the group of gaming machines, lottery machines, and sweepstakes machines.

12. The method of claim 1, wherein the step of inputting a value of credits includes inputting a card selected from the group of credit cards, bank cards and debit cards.

13. The method of claim 1, wherein the step of inputting a value of credits includes inputting currency.

14. The method of claim 1, including the step of signaling the video machine by the player that play is over to initiate the steps of encoding and ejecting the readable/encodable card.

15. The method of claim 1, including the step of collecting game usage data associated with the encoded card.

16. The method of claim 3, including the step of erasing data encoded on any readable/encodable card and adding the erased card to the stored quantity.

17. The method of claim 1, wherein the step of enrolling the player at the video machine includes inputting personal information from the player into an input device on the video machine.
